(19) United States
(12) Patent Application Publication
(10) Pub. No.: US 2005/0235283 A1
(43) Pub. Date: Oct. 20, 2005

(54) Automatic setup of parameters in networked devices

(76) Inventor: Christopher S. Wilson, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 11/107,224

(22) Filed: Apr. 15, 2005

Related U.S. Application Data
(60) Provisional application No. 60/562,830, filed on Apr. 15, 2004.

(51) Int. Cl. G06F 9/445; H04J 3/08; H04B 7/14

(52) U.S. Cl. 717/178; 370/315

(57) ABSTRACT

Various aspects of the invention provide one or more systems and methods that allow a user to efficiently setup and configure a data processing device. The various aspects of the invention facilitate ease of configuration by providing a user interface that allows a user to easily input one or more parameters. In one representative embodiment, the parameters input during the initialization process comprise the data processing device's time, date, and time zone. In another representative embodiment, a system for automatically configuring one or more parameters in a device comprises a memory, one or more files stored in the memory, a first application used for viewing the one or more files, a second application used for processing the one or more files in which the processing is used to generate a user interface for configuring the one or more parameters of the device.

### CROSS-REFERENCE TO RELATED APPLICATIONS/INCORPORATION BY REFERENCE

This application makes reference to and claims priority from U.S. Provisional Patent Application Ser. No. 60/562830, entitled “AUTOMATIC SETUP OF PARAMETERS OF DEVICES IN NETWORKS”, filed on Apr. 15, 2004, the complete subject matter of which is incorporated herein by reference in its entirety.

This application is related to and/or makes reference to:
U.S. application Ser. No. 11/049905 (Attorney Docket No. 15673US02) filed Feb. 3, 2005;
U.S. application Ser. No. ______ (Attorney Docket No. 15675US03) filed Mar. 22, 2005;
U.S. application Ser. No. ______ (Attorney Docket No. 15676US02) filed Apr. 15, 2005;
U.S. application Ser. No. ______ (Attorney Docket No. 15678US02) filed Apr. 8, 2005;
U.S. application Ser. No. _____ (Attorney Docket No. 15679US02) filed Apr. 8, 2005;
U.S. application Ser. No. ______ (Attorney Docket No. 15680US02) filed Apr. 15, 2005;
U.S. application Ser. No. ______ (Attorney Docket No. 15681US03) filed Mar. 30, 2005;
U.S. application Ser. No. 11/049772 (Attorney Docket No. 15682US02) filed Feb. 3, 2005;
U.S. application Ser. No. 11/049798 (Attorney Docket No. 15683US02) filed Feb. 3, 2005;
U.S. application Ser. No. ______ (Attorney Docket No. 15684US02) filed Mar. 22, 2005; and
U.S. application Ser. No. 11/049768 (Attorney Docket No. 15685US02) filed Feb. 3, 2005.

The above stated applications are hereby incorporated herein by reference in their entireties.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

When a data processing or computing device is introduced into a computer network, the date and time of the data processing or computing device is usually input. Often, a user must manually configure the clock settings of the newly introduced device. This may involve a number of complex operations. In addition, the user must determine the actual time before manually inputting it into the data processing or computing device. As a consequence, the user may spend unnecessary time performing tasks which otherwise could have been spent doing productive work. In addition, the complexity of the one or more tasks required to properly configure the computing device may ultimately lead to user frustration.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention provide at least a system and a method that allows a user to efficiently setup and configure a data processing device (or computing device), substantially shown and described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 illustrates a block diagram of a typical system incorporating the use of a NAS in accordance with an embodiment of the invention.

FIG. 2 is a block diagram of a network attached storage device (NAS) in accordance with an embodiment of the invention.

FIG. 3 is a block diagram of a NAS chip (NASoC) in accordance with an embodiment of the invention.

FIGS. 4A and 4B are operational flow diagrams of the process in which a user interface is generated by an exemplary NAS by way of executing one or more configuration file(s), in accordance with an embodiment of the invention.

FIG. 5 is a screen shot of an exemplary Microsoft Windows Explorer that illustrates the directory contents of a NAS having an exemplary default name, Viresh-NAS, in accordance with an embodiment of the invention.

FIG. 6 is a screen shot of an exemplary Microsoft Windows Explorer application illustrating configuration files contained within a directory, in accordance with an embodiment of the invention.

FIG. 7 illustrates a screen shot of an exemplary browser that indicating that a configuration file is being processed, in accordance with an embodiment of the invention.

FIG. 8 illustrates a screen shot of an exemplary web browser that allows a user to input one or more parameters, in accordance with an embodiment of the invention.

### DETAILED DESCRIPTION OF THE INVENTION

Aspects of the invention provide a system and method that allows a user to efficiently setup and configure a data processing device (or computing device). Various aspects of the invention facilitate inputting one or more parameters for initializing the operation of a data processing device. In a representative embodiment, the data processing device to be setup and initialized, by way of inputting the one or more parameters, may comprise a data storage device. The data processing device, however, may not be limited to that of a data storage device. As such, the data processing device may comprise a computer, PDA, laptop, digital cybercam, digital camera, personal video recorder (PVR), or the like. In a representative embodiment, the data storage device provides centralized storage for one or more data processing or computing devices. The data storage device and the one or more data processing devices or computing devices may be communicatively coupled by way of a network. In a representative embodiment, the data storage device may provide shared access to data to any device communicatively coupled to it. In a representative embodiment, the data storage device may be used as a centralized storage facility for expanding the storage capacity used by the one or more data processing devices located in one or more networks. In a representative embodiment, the data storage device is connected to a network such as a wired local area network or wireless local area network, so that the one or more data processing devices connected to the network may write to or read from the data storage device through the network. As a consequence, the data storage device may be referred to as a network attached storage device (NAS).

In a representative embodiment of the present invention, the data processing or computing device's time, date, and time zone is automatically configured. The time is set by a user executing a command that synchronizes the NAS to another data processing device. The user may designate to which device within the network he wishes to synchronize. In a representative embodiment, the command is executed by running or executing a software or firmware that resides in a memory of the NAS. In a representative embodiment, the software or firmware resides in a random access memory of the NAS.

In an alternate representative embodiment, the NAS is synchronized using time obtained from a network timeserver such as a network time protocol (NTP) server. The NTP server may be recognized and accessed by using one or more IP addresses. The one or more NTP servers may communicate with the one or more data processing devices to be synchronized by way of any communication network, such as a local area network, wide area network, or virtual private network, for example.

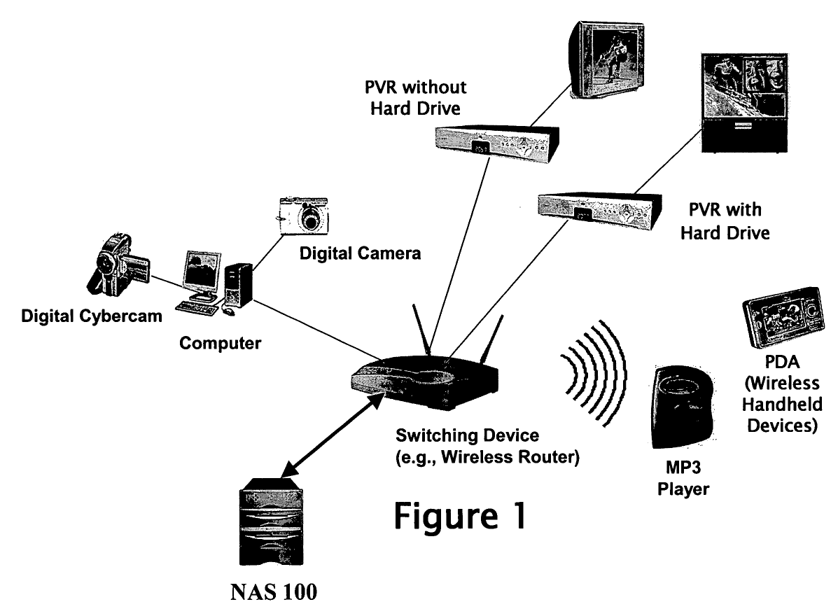

FIG. 1 illustrates a block diagram of a typical system incorporating the use of a NAS 100 in accordance with an embodiment of the invention. The exemplary NAS 100 provides data storage for one or more data processing devices. As illustrated, an exemplary switching device provides connectivity of the NAS 100 to the one or more data processing devices. The switching device is capable of providing connectivity using wireless or wireline communications. For example, a wireless router may utilize any one of the following wireless or wireline data communications protocols: 10/100 Ethernet, gigabit Ethernet, 802.11x, Bluetooth, and the like. The one or more data processing devices comprises devices such as a digital cybercam, digital camera, MP3 player, PDA, and one or more personal video recorders (PVRs). As illustrated, the PVR may be equipped with or without a hard disk drive. In one embodiment, the PVR may be referred to as a set-top-box (STB) that incorporates personal video recorder capabilities. In this embodiment, the PVR may be referred to as a PVR-STB. The PVRs illustrated, are connected to a television or a monitor capable of playing multimedia content to a home user. Use of the NAS 100 provides a centralized storage device for multimedia content received by the one or more PVRs. As a consequence of storing content in a NAS 100, PVRs lacking a storage facility, such as a hard disk drive, may store any data it receives into the NAS 100. Further, any data stored by other data processing devices, including PVRs, may be easily accessed and viewed by any of the one or more data processing devices. For example, a PVR without a hard drive may access multimedia content originally stored into the NAS 100 by a PVR with hard drive, and vice-versa. As a result, the NAS 100 facilitates sharing of data among the one or more data processing devices. Since it provides a remote storage mechanism, the NAS 100 may be considered a “virtual storage device” by the one or more data processing devices. The NAS 100 is configured such that its storage capacity may be easily expanded. In a representative embodiment, the NAS 100 may accept additional hard disk drives. As such, the NAS 100 provides an easily scalable and flexible storage mechanism that accommodates for future data storage growth. In addition, the NAS 100 is capable of providing data mirroring and data striping capabilities.

When the NAS is first introduced to the exemplary switching device shown in FIG. 1, one or more of its parameters may be setup as part of an initialization process. In one embodiment, the parameters setup during the initialization process comprises the NAS' time, date, and time zone. The NAS, for example, may utilize the computer illustrated in FIG. 1 as a reference source in setting up its time, date, and time zone. It is contemplated that the NAS may utilize any one of the other data processing devices (e.g., digital cybercam, digital camera, PVR without hard drive, PVR with hard drive, MP3 player, or PDA) shown in FIG. 1 as a reference source in the initialization process.

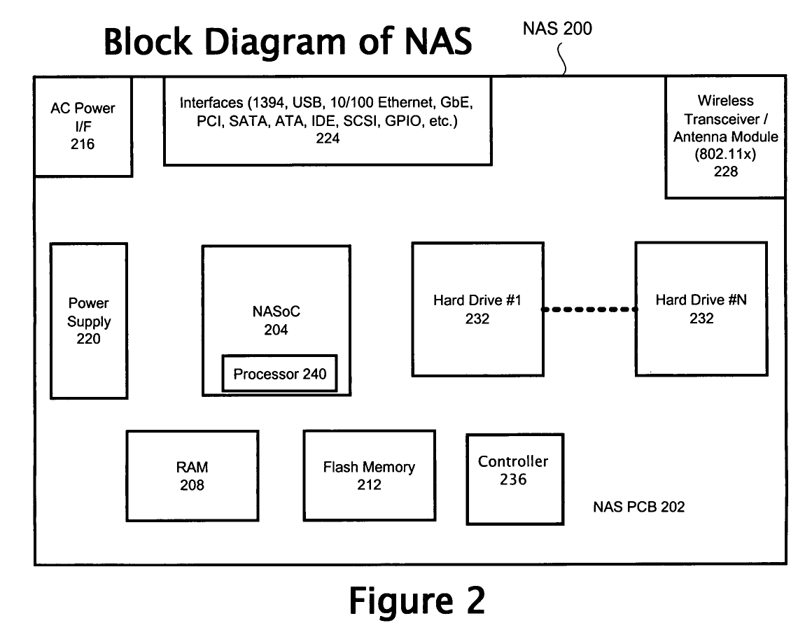

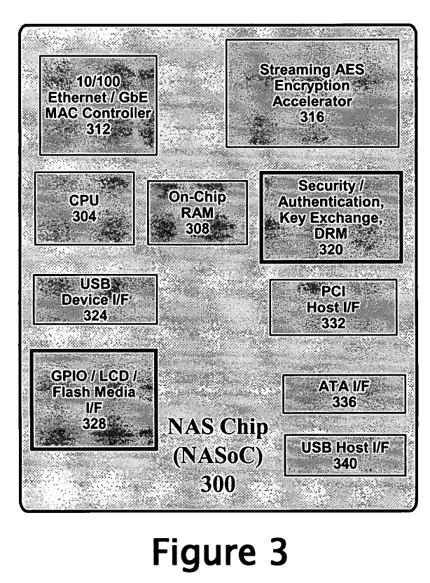

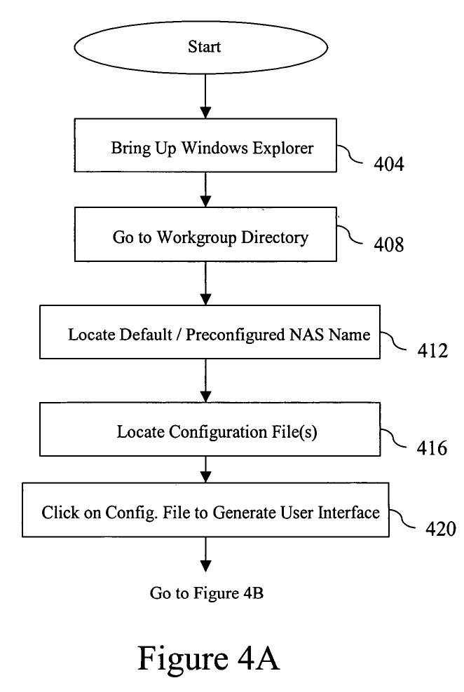

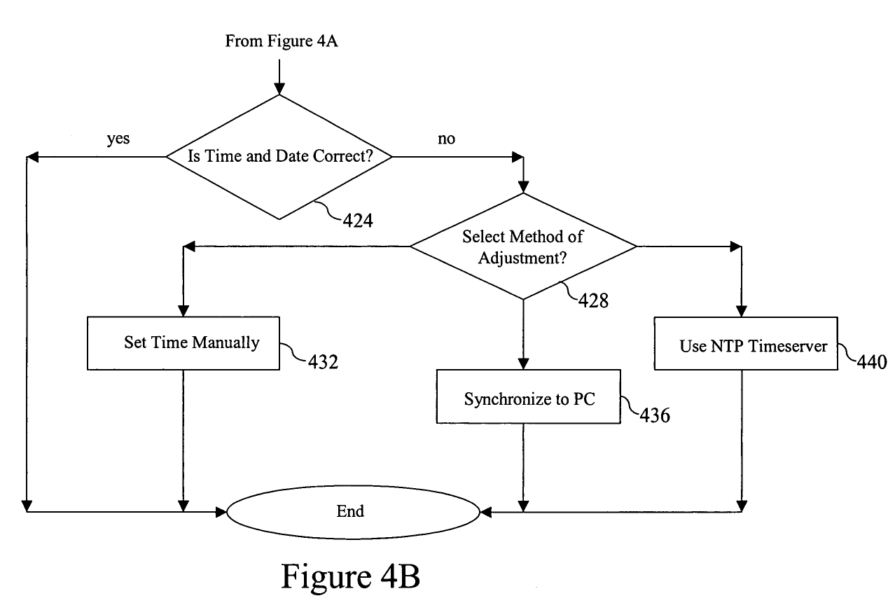

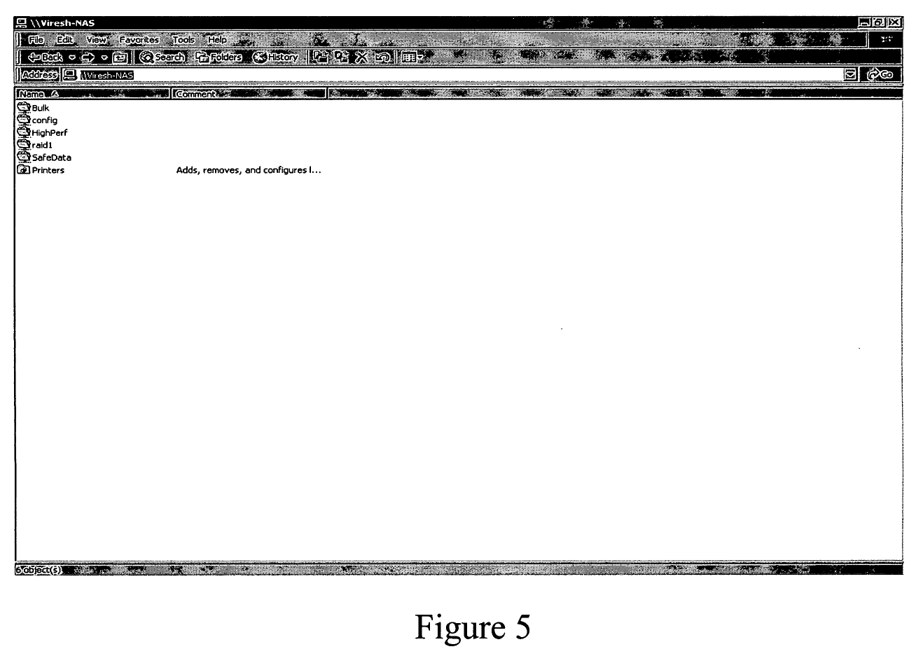

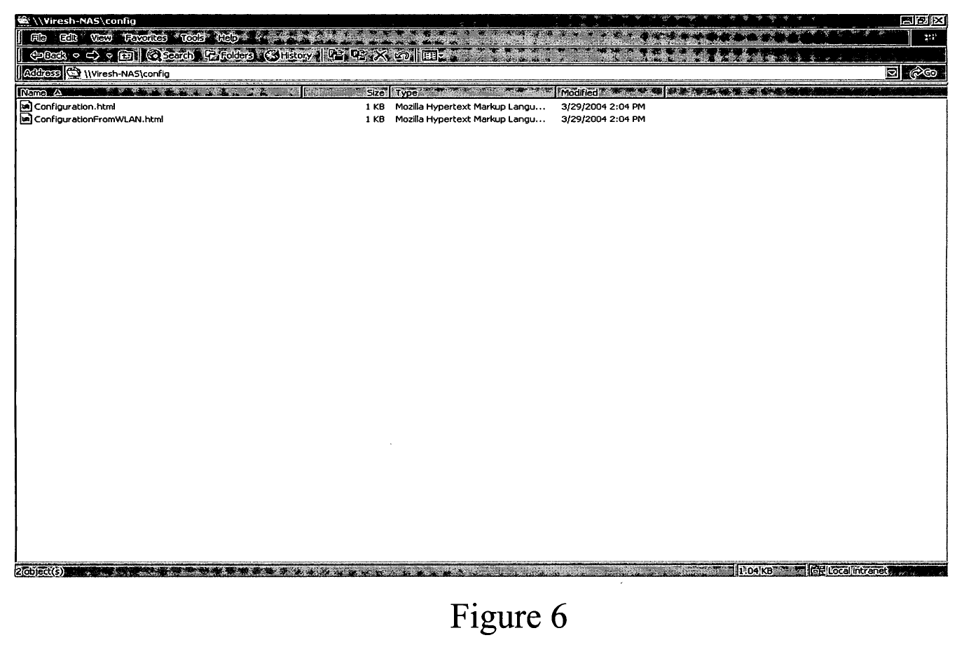

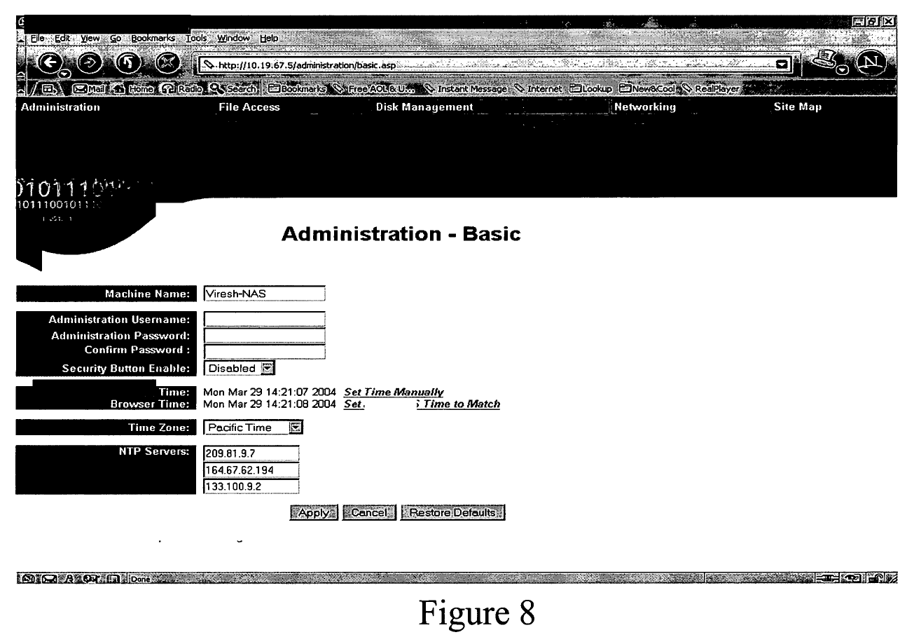

In a representative embodiment, the NAS setup or initialization process occurs after the NAS is physically connected to a network and recognized by an operating system such as a Microsoft Windows operating system. The following FIGS. 2 and 3 illustrate the NAS architecture while FIG. 4A provides an embodiment of an operational flow diagram describing how the NAS is automatically discovered by the Windows operating system, prior to setting up one or more parameters such as time, date, and time zone. FIGS. 5 and 6 illustrate pages displayed by a file organizing application (e.g., Microsoft Windows Explorer) that a user uses to initiate execution of the NAS' http server. FIG. 8 illustrates a browser page that is automatically generated when the NAS' http server serves one or more files to a data processing or computing device. In this representative embodiment, the browser page provides a user interface, such as a graphical user interface (GUI), used for inputting one or more values or parameters, such as date, time, and time zone.

FIG. 2 is a block diagram of a network attached storage device (NAS) 200 in accordance with an embodiment of the invention. The NAS 200 comprises a printed circuit board (NAS PCB) 202 containing one or more components. The one or more components are electrically connected by way of the printed circuit board (PCB) 202. The one or more components comprises a NAS chip (NASoC) 204, which will be described later with respect to FIG. 3, a random access memory 208, a flash memory 212, an AC power interface 216, a power supply 220, one or more interfaces 224, a wireless transceiver/antenna module 228, one or more hard disk drives 232, and a controller 236. The one or more interfaces 224 may comprise the following interfaces: IEEE 1394, USB, 10/100 Ethernet, gigabit Ethernet, PCI, SATA, ATA, IDE, SCSI, GPIO, etc. The wireless transceiver/antenna module 228 may comprise an attachable module or mini-PCI card that may be optionally connected or attached to the NAS' printed circuit board 202. The one or more hard disk drives 232 may comprise any number of hard drives depending on the design of the NAS 200. The printed circuit board 202 may be configured to accommodate an appropriate number of hard disk drives. The number of hard drives utilized may depend on the type of mirroring or data striping (i.e., RAID) provided by the NAS 200. In one embodiment, the controller 236 provides control for any one of several devices connected to the NASoC 204. The NASoC 204 may comprise an integrated circuit chip incorporating a processor or central processing unit (CPU) 240.

One or more methods of accessing data stored in the NAS may be accomplished by the NAS executing a software (or firmware) resident in the NAS. The software may be downloaded into a memory of the NAS by way of control provided by, for example, the PC or another data processing or computing device. In a representative embodiment, the memory comprises the flash memory described in reference to FIG. 2. As referenced in FIG. 2, the NAS may comprise a motherboard or printed circuit board (PCB) containing the memory in which the software may be stored. In addition, the PCB may incorporate a processor or CPU that performs the execution of the software resident in the memory. In a representative embodiment, the processor or processing circuitry is implemented within the NASoC.

FIG. 3 is a block diagram of a NAS chip (NASoC) 300 in accordance with an embodiment of the invention. The NASoC 300 is an integrated circuit mounted on the previously described NAS PCB. The NASoC 300 provides one or more functions that allow the NAS to properly operate. The NASoC 300 comprises a central processing unit (CPU) 304, an on-chip random access memory 308, a Ethernet/MAC controller 312, an encryption accelerator 316, a security/authentication, key exchange, DRM chip 320, and a number of interfaces 324, 328, 332, 336, 340. The interfaces 324, 328, 332, 336, 340 may comprise, for example, the following type of interfaces: USB device I/F 324, a PCI host I/F 332, a GPIO/LCD/flash media I/F 328, an ATA I/F 336, and a USB host I/F 340. The NAS chip 300 (204 in FIG. 2) may communicate and/or connect to the one or more components described in reference to FIG. 2.

Referring to FIG. 2, the NAS may incorporate varying numbers of hard disk drives depending on its storage and RAID requirements. The NAS 200 chassis may be configured to incorporate 1, 2, 4 or more hard disk drives depending on type of use. For example, the NAS may utilize 4 hard disk drives for implementing RAID 0+1 (both data mirroring and data striping), suitable for use in a small office/business environment. On the other hand, the NAS may utilize only 1 or 2 hard disk drives in a home (or household) environment since the storage capacity utilized is typically less than that utilized in an office or business environment. Similarly, memory components utilized in the NAS may be varied depending on type of use. As the data storage requirements increase and as the frequency of data storage related requests increase, the performance of the NAS may be improved to meet its operational needs, by way of increasing memory size of the NAS. For example, flash or DRAM memory capacities may be increased in order to improve the processing performance of the NAS.

In a representative embodiment, a NAS may be incorporated into an existing network. The exemplary NAS facilitates generation of a user interface by way of serving one or more files to a data processing device. The NAS may act as a server to serve one or more files to the data processing device, such that a user interface is generated at the data processing device. The data processing device acts as a client to the NAS. When served by the exemplary NAS, the user interface is generated at the data processing device such that a user may input one or more values and/or parameters. The user interface may provide one or more fields in which the user may input alphanumeric text. In a representative embodiment, the NAS serves one or more files to a browser application (i.e., such as Microsoft Internet Explorer or Netscape Navigator). The browser application resides in a memory (i.e., a storage media such as a hard disk drive) of the data processing device. The browser application generates one or more user interfaces using the one or more files. The one or more files may be executed, for example, by clicking on its filename as displayed by the Microsoft Windows Explorer application. The one or more user interfaces may comprise a user-friendly graphical user interface (GUI). In a representative embodiment, the processor 240 within the NASoC (204 or 300) may execute the one or more files. The data files may comprise software or firmware residing within the RAM 208 or flash memory 212. The GUI may display one or more fields in which a user may input alphanumeric values to configure the NAS. For example, the time, time zone, and date may be configured. In a representative embodiment, the software that is executed by the processor 240 comprises a configuration file that is recognized and used by an operating system, such as a Microsoft Windows operating system. The configuration file is capable of being displayed to a user. In a representative embodiment, the initialization process may involve inputting one or more authentication passwords that may be used by a user in the future for accessing and selecting the configuration file. The Microsoft Windows operating system may comprise Windows XP, 2000, ME, 98, Pocket PC, or the like. The user may input the following: a name for the NAS, an administration username, an administration password, time, time zone, date, and network time server internet protocol addresses. One or more embodiments of viewing and utilizing a configuration file may be found in U.S. patent application Ser. No. ______, entitled “AUTOMATIC DISCOVERY OF A NETWORKED DEVICE” and filed Apr. 15, 2005 (Attorney Docket No. 15676US02), the complete subject matter of which is incorporated herein by reference in its entirety.

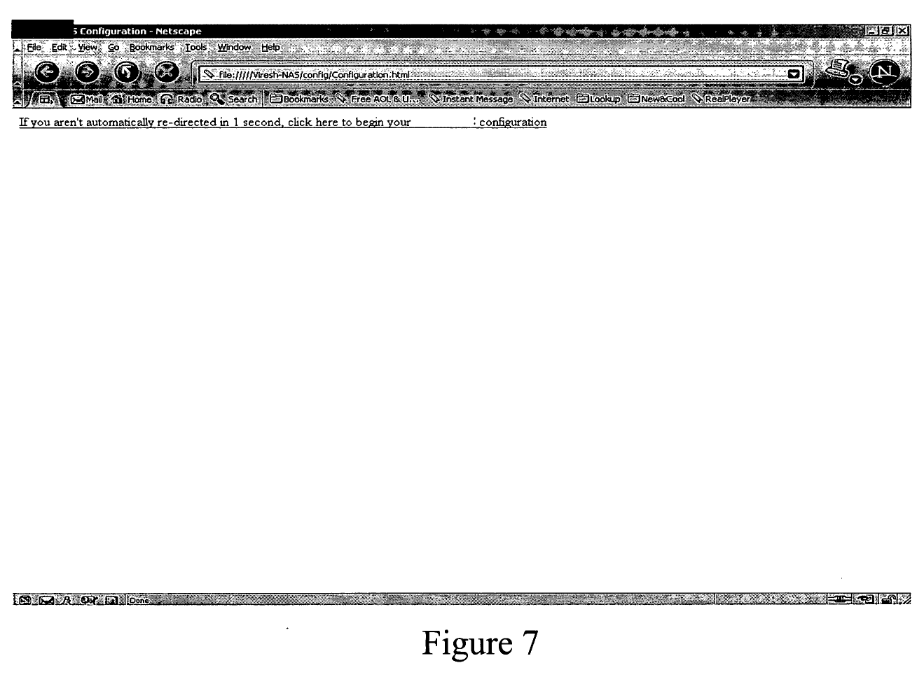

FIGS. 4A and 4B are operational flow diagrams of the process in which a user interface is generated by an exemplary NAS by way of executing one or more configuration file(s), in accordance with an embodiment of the invention. At step 404, a user runs an application that allows a user to view one or more data processing or computing devices in a network and their associated directories and files. One such application comprises the Microsoft Windows Explorer application, which may be resident in a memory (i.e., a hard disk drive) of the user's data processing device. The Microsoft Windows Explorer application may be used to view and locate one or more directories and their associated files. At step 408, a directory, such as a Workgroup directory (as may be found in Microsoft Windows Explorer) is accessed by the user, by “clicking” or selecting an identifier in the exemplary Microsoft Windows Explorer user interface. In a representative embodiment, the Microsoft Windows operating system provides a mechanism that identifies and displays any data processing devices that employ such configuration files. One or more data processing devices containing the one or more configuration files are displayed to the user by way of using Microsoft Windows Explorer, for example. The data processing devices that are displayed are identified by one or more default names. At step 412, the user locates and selects a data processing device, such as an exemplary NAS device, by “clicking” on one of the appropriate default NAS name(s) displayed by the Workgroup directory in Microsoft Windows Explorer, in order to access its configuration file. Of course, the exemplary NAS device must be communicatively coupled to the user's data processing device. In a representative embodiment, the NAS may be communicatively coupled to the user's data processing device by way of a wired local area network. Yet, in another representative embodiment, the NAS may be communicatively coupled to the user's data processing device by way of a wireless area network. FIG. 5 provides an exemplary screen shot of a Microsoft Windows Explorer application illustrating the directory contents of an exemplary NAS, named Viresh-NAS. It is contemplated that a default name is preconfigured for each NAS at the time of its manufacture. FIG. 5 is a screen shot of an exemplary Microsoft Windows Explorer that illustrates the directory contents of a NAS having an exemplary default name, Viresh-NAS, in accordance with an embodiment of the invention. As illustrated Viresh-NAS comprises the following directories: Bulk, config, HighPerf, raid1, SafeData, and Printers. At step 416, the user locates the appropriate one or more configuration file(s) from the Viresh-NAS\config directory. FIG. 6 is a screen shot of an exemplary Microsoft Windows Explorer application illustrating configuration files contained within the Viresh-NAS\config directory, in accordance with an embodiment of the invention. As illustrated, the Viresh-NAS\config directory comprises two files, Configuration.html and ConfigurationFromWLAN.html. In this representative embodiment, the Configuration.html is associated with setting up the Viresh-NAS over a wired local area network while ConfigurationFromWLAN.html is associated with setting up the Viresh-NAS over a wireless local area network. At step 420, the appropriate one or more configuration file(s) are identified and executed using a device. The device that identifies and executes the one or more configuration file(s) may comprise a mouse, for example. Execution of the one or more configuration file(s) allows an http server (e.g., such as the exemplary NAS), to serve one or more configuration files to a browser application that resides in an exemplary hard disk drive of another data processing device (e.g., a client computing device). The browser application may comprise Netscape Navigator or Microsoft Internet Explorer, for example. In a representative embodiment, the browser may notify the user that the configuration file is being processed, as illustrated in the representative embodiment of FIG. 7. FIG. 7 illustrates a screen shot of an exemplary browser that indicates that a configuration file is being processed, in accordance with an embodiment of the invention. Thereafter, Viresh-NAS generates a user interface (by way of a file that is served to the client computing device) that allows the user to configure the NAS.

FIG. 8 illustrates a screen shot of an exemplary web browser that allows a user to input one or more administrative parameters, in accordance with a representative embodiment of the invention. The one or more administrative parameters comprise a machine name for the NAS, an administration username, an administration password, time, date, time zone, and network time server internet protocol addresses. At step 424, the process proceeds to FIG. 4B in which a decision is made whether the time and/or date displayed by the user interface is correct. If the time and/or date is incorrect, the process proceeds to step 428. Otherwise, the process ends. At step 428, a decision is made regarding the type of adjustment to be performed. If a manual adjustment is preferred, the user selects the “Set Time Manually” button on the user interface and manually adjusts the time to suit his preferences, as shown at step 432. It is contemplated that “clicking” or selecting this button generates a user interface allowing a user to input or set time manually. At step 436, if the user wishes to synchronize the NAS to his personal computer (PC), for example, he may select the “Set Time to Match” button, as shown in FIG. 8. Otherwise, at step 440, the user proceeds to adjust the current time using an NTP timeserver approach by way of inputting one or more NTP IP addresses into the user interface.

In one embodiment, the NAS keeps track of the date and time and uses this information for time stamping any files it may store. Further, the NAS may utilize time and date for error and logging functions. In one embodiment, the NAS' system clock incorporates a small battery to keep the clock running when power to the NAS is turned off. As a result, once the date and time have been set on the NAS, any power loss will not affect the NAS' system clock.

As previously mentioned, FIG. 8 illustrates an example of how the NAS displays the current date and time to a user. If the date and time is incorrect or requires adjustment, the user interface provides “buttons” and/or “pull-down fields” to allow the time, date, and time zone to be adjusted. For example, a button named “Set Time Manually” may be “clicked” by the user using his mouse or other “point and click” device such that the time may be manually set by the user. Alternatively, a different button such as “Set Time to Match” may be “clicked” by the user to synchronize the NAS to the system clock of a data processing device (or client device) that generates the user interface. When using the “Set Time to Match” button, the date and time may be obtained by way of a JavaScript enabled browser, such as Microsoft Internet Explorer, that invokes one or more built in functions. In a representative embodiment, the one or more built in functions comprise a getTime or getTimeZoneOffset function.

In one embodiment, the NAS is also capable of obtaining and maintaining the date and time from a network by accessing current time from an NTP timeserver. A NAS may synchronize itself with an NTP timeserver by way of communications through a network or through the Internet. In this embodiment, there are three input fields provided by the user interface for inputting the IP addresses of three different NTP timeservers.

In the representative embodiment of FIG. 8, the user interface also provides a “pull-down field” allowing a user to select one or more time zones. For example, the user may select Pacific time zone if he is currently located in the State of California.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of automatically configuring a first device, said first device communicatively coupled to a network, said method comprising:
first identifying said first device using an application resident in a second device, said application capable of viewing one or more files in one or more directories of said first device;
second identifying a file from said one or more files using said application;
executing said file by way of said application to generate a user interface in said second data processing device; and
inputting one or more values or parameters by way of using said user interface.

2. The method of claim 1 wherein said application comprises a web browser.

3. The method of claim 1 wherein said web browser comprises Microsoft Internet Explorer.

4. The method of claim 1 wherein said web browser comprises Netscape Navigator.

5. The method of claim 2 wherein said one or more parameters comprises time.

6. The method of claim 5 wherein said time is input manually using said user interface.

7. The method of claim 5 wherein said time is synchronized to said time of said second device.

8. The method of claim 7 wherein said synchronization is performed using said web browser that is Javascript enabled.

9. The method of claim 5 wherein said time is synchronized to an NTP server.

10. The method of claim 2 wherein said one or more parameters comprises date.

11. The method of claim 10 wherein said date is input manually using said user interface.

12. The method of claim 10 wherein said date is synchronized to said second device.

13. The method of claim 12 wherein said synchronization is performed using said web browser that is Javascript enabled.

14. The method of claim 10 wherein said date is synchronized to an NTP server.

15. The method of claim 2 wherein said one or more parameters comprises time zone.

16. The method of claim 15 wherein said time zone is input manually using said user interface.

17. The method of claim 16 wherein said time zone is set to correspond to that of said second device.

18. The method of claim 1 wherein said one or more values or parameters comprises a password.

19. A system for automatically configuring one or more parameters in a first computing device, said first device communicatively coupled to a network, said system comprising:
a memory in said first computing device;
one or more files stored in said memory of said first computing device;
a second computing device communicatively coupled to said network;
a first application resident in a hard disk drive of said second computing device that is capable of viewing said one or more files, said second computing device used to identify and initiate execution of said one or more files using said first application; and
a second application resident in said hard disk drive of said second computing device used for processing said one or more files when said one or more files are received from said first computing device, said processing used to generate a user interface for said configuring said one or more parameters of said first device.

20. The system of claim 19 wherein said first application comprises Microsoft Windows Explorer.

21. The system of claim 19 wherein said second application comprises a web browser.

22. The system of claim 21 wherein said web browser comprises Microsoft Internet Explorer.

23. The system of claim 21 wherein said web browser comprises Netscape Navigator.

24. The system of claim 19 wherein said one or more parameters comprises time.

25. The system of claim 19 wherein said one or more parameters comprises date.

26. The system of claim 19 wherein said one or more parameters comprises time zone.

27. A method of automatically configuring the current time in a first computing device, said first computing device communicatively coupled to a network, said method comprising:
downloading one or more files from said first computing device to a second computing device;
processing said one or more files by an application of said second computing device; and
generating a user interface by said application, said user interface used for said configuring said time for said first computing device.

28. The method of claim 27 wherein said application comprises a web browser.
